(19) United States
(12) Patent Application Publication
(10) Pub. No.: US 2026/0219436 A1
(43) Pub. Date: Jul. 30, 2026

(54) ILLUMINATED GLAZING ELEMENT WITH EMISSIVITY-REDUCING COATING

(71) Applicant: SAINT-GOBAIN SEKURIT FRANCE, THOUROTTE (FR)

(72) Inventors: Anna NEFT, HERZOGENRATH (DE); Nariaki SAKAI, HERZOGENRATH (DE); Jan HAGEN, HERZOGENRATH (DE)

(21) Appl. No.: 19/147,510

(22) PCT Filed: Jan. 11, 2024
(86) PCT No.: PCT/EP2024/050597

§ 371 Date: Jul. 11, 2025

(30) Foreign Application Priority Data
Jan. 13, 2023 (EP) 23151528.9

(51) Int. Cl. F21V 8/00; B32B 17/10; B60Q 3/208; E06B 3/54; E06B 3/66

(52) U.S. Cl. CPC G02B 6/0043; B32B 17/10036; B32B 17/10229; B32B 17/10541; E06B 3/5481; E06B 3/66; G02B 6/0065; G02B 6/0095; B32B 2605/00; B60Q 3/208

(57) ABSTRACT

An illuminated glazing element includes a glass pane having a first surface and a second surface, wherein the glazing element is equipped with at least one light source which is suitable for coupling light into the glass pane in such a way that the light propagates in the glass pane, and is provided with at least one light-scattering structure which is suitable for decoupling the light from the glass pane via the first surface and/or via the second surface, wherein the second surface of the glass pane is provided with an emissivity-reducing coating which includes exactly one electrically conductive layer based on a transparent conductive oxide and the electrically conductive layer has, within the wavelength range from 380 nm to 780 nm, an imaginary component k of the refractive index, for which k<0.035 applies.

The invention relates to an illuminated glazing element having at least one glass pane, to a method for the production thereof, and to the use thereof.

Illuminated glass panes are known as such. For illumination, the glass pane is equipped with a light source, typically a light-emitting diode, the light of which is coupled into the glass pane in such a way that it propagates in the glass pane in the manner of a light guide, in particular by total reflection at the surfaces of the glass pane. The light can be coupled back out of the glass pane by light-scattering structures, thus realising the illumination. The shape of the light-scattering structures can be freely selected, so that illuminated surfaces of any shape can be generated, for example as a pattern. Illuminated glass panes of this type are known, for example, from WO2014/060409A1, WO2014/167291A1 or the subsequently published application WO2023/144282. The light can be coupled in via the side edge surface of the glass pane, via the edge surface of a recess in the glass pane or via one of the main surfaces of the glass pane. In the latter case, the light is emitted through the glass pane and reflected back into the glass pane by a light incoupling means opposite the light source in such a way that the condition of total reflection is fulfilled. For this purpose, the light incoupling means has correspondingly inclined reflective surfaces. For example, microprism films can be used as light incoupling means.

In the automotive sector, such illuminated glass panes are particularly interesting as roof windows. The illuminated glass pane is typically the inner pane of a laminated pane. However, such illuminated glass panes can also be used for other vehicle windows or window panes in the building and architectural sector or in furnishing items.

Glass panes are also known which are equipped with emissivity-reducing coatings (known as low-E coatings), which improve the thermal comfort in the interior of the vehicle by reflecting thermal radiation. Transparent emissivity-reducing coatings can, for example, contain a functional layer based on indium tin oxide (ITO). Reference is made by way of example to WO2013131667A1, WO2018206236A1, DE202022100518U1 and DE202013006875U1. The emissivity-reducing coatings are typically provided on the interior surface of the glass pane (or the entire glazing element if it comprises more than one single glass pane) and have reflective properties in the mid-IR range. In summer, they reduce the amount of thermal energy from the heated glass pane entering the interior. In winter, they reduce the radiation of heat in the interior through the glass pane into the outside environment.

It is known in principle from WO2022/136107A1 and WO 2007/077099A1 that an emissivity-reducing coating of this type can be applied to a surface of an illuminated glass pane of the type mentioned at the outset. However, undesirable effects may occur. The coating influences the reflection behaviour of said surface, on which the total reflection of the light from the light source coupled into the glass pane also takes place. The coating can lead to a loss of intensity of the coupled-in light and/or to a change in its colour (“colour cast”).

There is therefore a need for emissivity-reducing coatings that can be used on illuminated glass panes of the type mentioned at the outset without the coating having negative impacts on the illumination.

The object of the present invention is to provide an illuminated glazing element having at least one glass pane, the glass pane serving to distribute the light of a light source in the glazing element and being provided with an emissivity-reducing coating, hereinafter also referred to as a low-E coating. The coating should not lead to a significant loss of intensity of the coupled-in light nor to a change in its colour. The glazing element should also have low emissivity, a low degree of reflection to the interior and as neutral an interior reflection colour as possible. In addition, the coating should be able to be produced efficiently and cost-effectively.

The object of the present invention is achieved by an illuminated glazing element according to claim 1. Preferred embodiments result from the dependent claims.

Within the meaning of the invention, the illuminated glazing element is a pane-like or plate-like object that comprises at least one glass pane and, in particular, is structurally formed from at least one glass pane. The glazing element can be a single glass pane and structurally consist only of said glass pane. The glass element can alternatively be a laminated pane or insulating glazing that contains said glass pane. With a laminated pane, the glass pane is connected to another pane via a thermoplastic intermediate layer. In the case of insulating glazing, the glass pane is connected to another pane via a circumferential spacer in the edge region, as a result of which a space that is typically filled with inert gas or evacuated is formed between the panes. The glazing element can be used as a window pane, for example as a window pane for vehicles, buildings or interiors. However, the glazing element can also be used as a component of furniture or electrical appliances, for example as a door pane of a cupboard or shelf or as a pane of an oven door. The glazing element can also be used as a furnishing item, for example as a display panel in bars or nightclubs.

The illuminated glazing element according to the invention comprises at least one glass pane. The glass pane has a first surface (main surface) and a second surface (main surface), which are typically substantially parallel to each other, and a side edge surface extending between the first and second surface.

The glazing element, or the glass pane, can be flat or curved in one or more directions of the space. In the latter case, typically one of the surfaces is concave and the other convex. The side edge surface can be flat. However, it is common practice to grind the side edge surface to minimise the risk of injury from it. The side edge surface is then curved or rounded, in particular convexly curved or rounded.

The glazing element, in particular the glass pane, is equipped with at least one light source which is suitable for coupling the light emitted thereby into the glass pane in such a way that the light propagates (at least) in the glass pane.

The light is propagated in the glazing element in particular by total reflection at two interfaces to an optically less dense medium (medium with a lower refractive index). One of these interfaces is the second surface of the glass pane, which is provided with the emissivity-reducing coating. This is preferably an exposed surface of the glazing element, and the adjacent optically less dense medium is preferably air. The other interface is preferably the first surface of the glass pane-then the light propagates only in the glass pane. In particular, if the glazing element is in the form of a laminated pane, at least one further layer can be in contact with the first surface, which has substantially the same refractive index as the glass pane, so that the first surface does not constitute a reflective interface. In this case, the other interface is the surface of said at least one further layer, this surface facing away from the glass pane, where there is a transition to an optically less dense medium.

In other words, the light is propagated in the glazing element by total reflection at the second surface of the glass pane, which is provided with the emissivity-reducing coating, and a further interface, which is preferably the first surface of the glass pane, but in the case of a laminated pane can also be formed by the surface of a layer facing away from the glass pane, which is in contact with the first surface and has the same refractive index as the glass pane.

The glazing element is also provided with at least one light-scattering structure which is suitable for decoupling said light from the glass pane via its first surface and/or via its second surface. The light-scattering structure is arranged on or formed in one of the totally reflective surfaces or between the totally reflective surfaces. Preferably, the light-scattering structure is arranged on the first or second surface of the glass pane or formed therein. When the light propagating in the glazing element strikes the light-scattering structure, it is scattered, which prevents total reflection, so that the scattered light is decoupled from the glazing element (in particular the glass pane) and leaves the glazing element.

According to the invention, the second surface of the glass pane is provided with an emissivity-reducing coating which has exactly one electrically conductive layer based on a transparent conductive oxide (also referred to as TCO) and the electrically conductive layer has, within the wavelength range from 380 nm to 780 nm, an imaginary component k of the refractive index, for which k<0.035 applies. This means that for each wavelength within the wavelength range from 380 nm to 780 nm, the electrically conductive layer has an imaginary component k of the refractive index, for which k<0.035 applies. In the entire wavelength range, there is no k-value that is not less than 0.035. Preferably, within the wavelength range from 380 nm to 780 nm, the electrically conductive layer has an imaginary component k of the refractive index, for which k<0.030, particularly preferably k<0.025, applies. Exactly one electrically conductive layer means that, apart from the electrically conductive layer based on a TCO, there is no further electrically conductive layer inside, below or above the emissivity-reducing coating. If the low-E coating contains further layers beyond the electrically conductive layer, these are dielectric layers.

The complex refractive index ñ is composed of the sum of the real part of the refractive index n and the product of the imaginary part nᵢ multiplied by the imaginary number i:

$$\tilde{n} = n + i * {n}_{i}$$

The imaginary part nᵢ of the complex refractive index is also referred to as the extinction coefficient k. The extinction coefficient describes the attenuation capacity of an optical medium; the greater k is, the more incident light is absorbed by the material. The size of the extinction coefficient k depends on the chemical and crystallographic structure of the material.

The inventors have found that a low-E coating, comprising a single electrically conductive layer based on a TCO, is particularly suitable for obtaining a high intensity of the light irradiated into the glazing if the imaginary part of the refractive index of the TCO layer in the wavelength range from 380 nm to 780 nm is less than k=0.035. The wavelength range specified corresponds to that of visible light, in which the illuminated glazing element is also operated. If the extinction coefficient is chosen to be this small, the light coupled into the illuminated glazing element is only slightly attenuated due to absorption and a 20 high light intensity of the illuminated glazing element is maintained.

Preferably, within the wavelength range from 380 nm to 490 nm, the electrically conductive layer has an imaginary component k of the refractive index, for which k<0.020, particularly preferably k<0.015, applies. Within the wavelength range from 490 nm to 575 nm, the electrically conductive layer preferably has an imaginary component k of the refractive index, for which k<0.015, particularly preferably k<0.010 applies. Preferably, within the wavelength range from 600 nm to 700 nm, the electrically conductive layer has an imaginary component k of the refractive index, for which k<0.025, particularly preferably k<0.020, applies. This makes it possible to maintain a particularly high light intensity in these wavelength 30 ranges. This means that for each wavelength within said wavelength range, the value for k is smaller than the specified value. The wavelength ranges in question are particularly relevant because typical light sources in violet/blue, green and red colours have emission wavelengths in these ranges.

The refractive index is essentially independent of the measurement method; it can be determined, for example, by means of ellipsometry. Ellipsometry is a common optical method for determining layer thicknesses and optical constants, and allows both the real and imaginary part of the refractive index to be determined. Ellipsometers are commercially available—for example, from the Sentech company.

The extinction coefficient of the electrically conductive layer is determined by measuring the imaginary part of the refractive index of the low-E coating within the wavelength range 380 nm to 780 nm. In addition to the electrically conductive layer, the low-E coating may also include dielectric layers. Dielectrics do not contribute to absorption and can therefore be neglected, so that direct conclusions about the electrically conductive layer can be drawn from the measurements of the low-E coating.

Unless otherwise stated, within the scope of the present invention refractive indices of further layers of the low-E coating are based essentially on a wavelength of 550 nm. The optical thickness is the product of the geometric thickness and the refractive index (at 550 nm). The optical thickness of a layer sequence is calculated as the sum of the optical thicknesses of the individual layers. Unless otherwise stated, the layer thicknesses indicated are geometric layer thicknesses.

The electrically conductive layer is preferably based on indium tin oxide (ITO). Alternatively, however, the conductive layer can also be based, for example, on indium-zinc mixed oxide (IZO), aluminium-doped zinc oxide (AZO, ZnO:Al), gallium-doped zinc oxide (GZO), fluorine-doped tin oxide (FTO, SnO₂:F), antimony-doped tin oxide (ATO, SnO₂:Sb) or niobium-doped titanium oxide (TiO₂:Nb). Such layers are corrosion-resistant and may be used on exposed surfaces. The real part of the complex refractive index of the TCO layer is preferably from 1.5 to 2.3.

If a layer (thin layer) of a coating is “based on” a material, the layer consists predominantly of this material, in particular substantially of this material, in addition to any impurities or doping. The electrically conductive layer based on a TCO is therefore formed predominantly thereof. Preferably, the electrically conductive layer based on a transparent conductive oxide comprises at least 90 wt. % of a TCO, particularly preferably at least 95 wt. % of a TCO, and consists in particular of a transparent conductive oxide.

Preferably, the electrically conductive layer is deposited by means of physical vapour deposition. In principle, it is possible to influence the extinction coefficient k via the oxygen content in the process gas during physical vapour deposition, in particular during magnetic-field-assisted cathode sputtering. In a preferred embodiment, an oxygen content of 1% by volume to 3% by volume is selected in the process gas. Such an oxygen content is particularly suitable for producing an electrically conductive TCO layer with an extinction coefficient k of less than 0.035 in the wavelength range from 380 nm to 780 nm. Particularly preferably, the electrically conductive layer is based on indium tin oxide (ITO) and deposited by means of physical vapour deposition with an oxygen content of 1% by volume to 3% by volume in the process gas. Particularly good results with regard to the absorption properties are thus achieved.

In a preferred embodiment, the emissivity-reducing coating has a specific sheet resistance of less than 250μΩ·cm, particularly preferably less than 200μΩ·cm.

The interior-side emissivity of the glazing assembly is preferably less than or equal to 40%, particularly preferably less than or equal to 35%, very particularly preferably less than or equal to 30%. Here, interior-side emissivity is the measure that indicates how much heat radiation the pane emits into an interior, for example of a building or of a vehicle, in the installed position compared to an ideal heat emitter (a black body). Within the meaning of the invention, emissivity is understood to mean the normal emissivity at 283 K according to the standard EN 12898.

The electrically conductive layer preferably has a thickness of from 60 nm to 100 nm, and preferably from 65 nm to 95 nm. In these ranges, a good emissivity-reducing effect of the low-E coating and at the same time a sufficiently low absorption of the electrically conductive layer is achieved.

The low-E coating preferably comprises one or more dielectric layers arranged above or below the one TCO layer. Typically, provided below and/or above the TCO layer is a dielectric layer or layer sequence, which improves the optical properties, in particular the transmission and reflectivity. The emissivity-reducing coating is then preferably a thin-film stack, i.e. a sequence of thin individual layers. Preferred embodiments of the emissivity-reducing coating with which particularly good results can be achieved are described below.

If a first layer is arranged above a second layer, this means, within the meaning of the invention, that the first layer is arranged further away from the substrate on which the coating is applied than the second layer. If a first layer is arranged below a second layer, this means, within the meaning of the invention, that the second layer is arranged further away from the substrate than the first layer. The low-E coating is preferably formed as a thin-film sequence, comprising several thin layers that are deposited surface-to-surface one above the other on the second surface of the glass pane. If a first of these thin layers is applied below a second thin layer, the distance between the first thin layer and the second surface of the glass pane is smaller than the distance between the second thin layer and the latter.

So-called anti-reflective layers or anti-reflection layers, which have a lower refractive index than the TCO layer and are arranged below and above the same, have a particular influence on the optical properties. These anti-reflective layers can increase the transmittance through the pane and reduce the reflectivity, in particular as a result of interference effects. The effect depends decisively on the refractive index and layer thickness.

In an advantageous embodiment, the emissivity-reducing coating preferably comprises a dielectric lower anti-reflective layer which is arranged below the TCO layer. The refractive index of the lower anti-reflective layer is preferably at most 1.8, for example from 1.3 to 1.8, particularly preferably at most 1.6, for example from 1.3 to 1.6. The thickness of the lower anti-reflective layer is preferably from 5 nm to 25 nm, particularly preferably from 5 nm to 20 nm.

In an advantageous embodiment, the emissivity-reducing coating preferably comprises a dielectric upper anti-reflective layer which is arranged above the TCO layer. The refractive index of the upper anti-reflective layer is preferably at most 1.8, for example from 1.3 to 1.8, particularly preferably at most 1.6, for example from 1.3 to 1.6. The thickness of the upper anti-reflective layer is preferably from 45 nm to 100 nm, particularly preferably from 50 nm to 75 nm.

In an advantageous embodiment, the emissivity-reducing coating has both a lower anti-reflective layer below the TCO layer and an upper anti-reflective layer above the TCO layer.

The anti-reflective layers in particular bring about advantageous optical properties of the pane. They increase the transparency of the pane and promote a neutral colour impression. The anti-reflective layers are preferably based on an oxide or fluoride, particularly preferably based on silicon oxide, magnesium fluoride or calcium fluoride, in particular based on silicon oxide (SiO₂). The silicon oxide can have dopants and is preferably doped with aluminium (SiO₂:Al), with boron (SiO₂:B), with titanium (SiO₂:Ti), with hafnium (SiO₂:Hf) or with zirconium (SiO₂:Zr).

A greater or lower level of transparency of the glazing may be desired or required, depending on the field of application of the illuminated glazing element. While a lower level of transparency is acceptable or even desirable for decorative glazing or motor-vehicle roof glazing, for example, a transmission of at least 70% in the visible range of the light spectrum is legally required for motor-vehicle windscreens.

The upper anti-reflective layer can be the top layer of the coating. This layer then has the greatest distance to the substrate surface (second surface of the glass pane) and is the final layer of the layer stack. Depending on the application and installation situation of the glazing element, this layer can also be exposed, i.e. can be accessed and touched by people. However, it is also possible for one or more further individual layers to be arranged above the upper anti-reflective layer. Such a further layer can, for example, serve to improve scratch protection and can be based on zirconium oxide, titanium oxide or hafnium oxide.

In an advantageous embodiment, between the TCO layer and the upper anti-reflective layer, the emissivity-reducing coating comprises an upper dielectric barrier layer for regulating oxygen diffusion with a refractive index of at least 1.9. The barrier layer serves to adjust the oxygen supply to an optimum level. Particularly good results are obtained if the refractive index of the barrier layer is from 1.9 to 2.5.

The upper dielectric barrier layer for regulating oxygen diffusion is preferably based on a nitride or a carbide. The upper dielectric barrier layer can be based, for example, on a nitride or carbide of tungsten, niobium, tantalum, zirconium, hafnium, chromium, titanium, silicon or aluminium. In a preferred embodiment, the upper dielectric barrier layer is based on silicon nitride or silicon carbide, in particular silicon nitride (Si₃N₄), which produces particularly good results. The silicon nitride can have dopants and in a preferred development is doped with aluminium (Si₃N₄:Al), with zirconium (Si₃N₄:Zr), with hafnium (Si₃N₄:Hf), with titanium (Si₃N₄:Ti), or with boron (Si₃N₄:B). During a temperature treatment after the application of the coating according to the invention, the silicon nitride can be partially oxidised. A barrier layer deposited as Si₃N₄ then contains SiₓN_{y}O_{z} after the temperature treatment, with the oxygen content typically ranging from 0 at. % to 35 at. %.

The thickness of the upper dielectric barrier layer is preferably from 5 nm to 40 nm, particularly preferably from 8 nm to 25 nm, very particularly preferably from 9 nm to 15 nm. This regulates the oxygen content of the TCO layer in a particularly advantageous way. The thickness of the barrier layer is selected in terms of oxygen diffusion and less in terms of the optical properties of the pane. However, it has been shown that barrier layers with thicknesses in the specified range are compatible with the emissivity-reducing coating according to the invention and the optical requirements thereof.

In an advantageous embodiment, the emissivity-reducing coating comprises a lower dielectric blocking layer against alkali diffusion below the TCO layer, and optionally below the lower anti-reflective layer. The blocking layer reduces or prevents the diffusion of alkali ions from the glass substrate into the coating system. Alkali ions can negatively affect the properties of the coating. The refractive index of the lower blocking layer is preferably at least 1.9. Particularly good results are obtained if the refractive index of the blocking layer is from 1.9 to 2.5. The blocking layer is preferably based on an oxide, a nitride or a carbide, preferably tungsten, chromium, niobium, tantalum, zirconium, hafnium, titanium, silicon or aluminium, for example oxides such as WO₃, Nb₂O₅, Bi₂O₃, TiO₂, Ta₂O₅, Y₂O₃, ZrO₂, HfO₂, SnO₂, or ZnSnOₓ, or nitrides such as AlN. The blocking layer is particularly preferably based on silicon nitride (Si₃N₄), which achieves particularly good results. The silicon nitride can have dopants and in a preferred development is doped with aluminium (Si₃N₄:Al), with titanium (Si₃N₄:Ti), with zirconium (Si₃N₄:Zr), with hafnium (Si₃N₄:Hf) or with boron (Si₃N₄:B). The thickness of the blocking layer is preferably from 10 nm to 50 nm, particularly preferably from 10 nm to 40 nm, for example from 15 nm to 35 nm. The blocking layer is preferably the bottom layer of the layer stack; i.e. it has direct contact with the substrate surface, where it can develop its effect optimally.

In a particularly advantageous embodiment, the coating consists only of the layers described and does not contain any further layers. The emissivity-reducing coating particularly preferably consists of the following layers in the specified order starting from the substrate surface (second surface of the glass pane):

blocking layer against alkali diffusion
a lower anti-reflective layer
electrically conductive layer based on a TCO
upper barrier layer for regulating oxygen diffusion
upper anti-reflective layer

If the glazing element according to the invention is a window pane (for example of a vehicle, a building, an interior, a piece of furniture or a furnishing item), it is intended to be inserted into a window opening where it is to separate an interior space from an external environment. The glass pane then has an outer surface and an interior-side surface. Within the meaning of the invention, the outer surface means the main surface which is intended to face the external environment when installed. Within the meaning of the invention, the interior-side surface means the main surface which is intended to face the interior when installed. Instead of being used as a window pane within the narrower meaning, the glazing element can equally be used as a door pane or facade glazing, with the above statements applying analogously.

The second surface provided with the emissivity-reducing coating is preferably the interior-side surface of the glass pane and particularly preferably the interior-side surface of the entire glazing element which is exposed to the interior. This is advantageous in terms of thermal comfort in the interior, because in particular the heat radiation from the heated glazing element into the interior is reduced to an optimal degree. In principle, however, it is also conceivable for the second surface of the glass pane to form the outer surface of the glass pane and/or even of the entire glazing element.

The emissivity-reducing coating is typically applied over the entire surface of the second surface, possibly with the exception of a peripheral edge region and/or other locally delimited regions, which can serve for data transmission or for coupling in light, for example. The coated portion of the substrate surface is preferably at least 80%.

In a first preferred embodiment, the glazing element according to the invention is a single glass pane and is structurally formed only from the glass pane, which serves as a light guide for the light from the light source. The totally reflective interfaces in this case are the first and second surface of the glass pane, which form exposed surfaces of the glazing element.

In a second preferred embodiment, the glazing element according to the invention is a laminated pane. In addition to the light-conducting glass pane with the emissivity-reducing coating and the light source, the laminated pane comprises a further pane (in particular a glass pane) which is connected to the light-conducting glass pane via a thermoplastic intermediate layer. The further pane also has a first surface, a second surface and a peripheral side edge surface extending therebetween. If the glass element is a window pane, one of the panes can be referred to as the outer pane and the other pane the inner pane. Within the meaning of the invention, inner pane means the pane of the laminated pane facing the interior when in the installed position. Outer pane means the pane facing the external environment. The interior-side surface of the outer pane and the outer surface of the inner pane face one another and the thermoplastic intermediate layer and are connected to one another by the thermoplastic intermediate layer.

Also in the case of the laminated pane, the totally reflective interfaces are preferably the first and second surface of the light-conducting glass pane. Typically, the glass pane has a refractive index that differs sufficiently from that of the intermediate layer as to ensure the total reflection. In principle, however, it is conceivable for a layer of the intermediate layer adjacent to the glass pane or even the entire intermediate layer to have the same refractive index as the glass pane, so that no total reflection occurs on the surface of the glass pane facing the intermediate layer. In this case, the reflective interface is formed by the nearest surface at which a transition to an optically less dense medium occurs. This interface can be located within the intermediate layer, on the surface of the further pane facing the intermediate layer or even on the surface of the further pane facing away from the intermediate layer.

The light-conducting glass pane with the emissivity-reducing coating is preferably the inner pane of the laminated pane; the further pane is the outer pane. The second surface of the glass pane provided with the emissivity-reducing coating is preferably the interior-side surface of the glass pane (inner pane), which faces away from the intermediate layer and the outer pane and is exposed to the interior. This achieves particularly good emissivity-reducing properties and particularly advantageously improves the thermal comfort in the interior.

Alternatively, it is also possible for the light-conducting glass pane with the emissivity-reducing coating to be the outer pane and the further pane to be the inner pane. In this case too, the second surface of the glass pane provided with the emissivity-reducing coating is the surface facing away from the intermediate layer, i.e. the outer surface exposed to the external environment.

The glazing element is provided with a light source that is suitable for coupling light into the glass pane. The light can be coupled in, in particular via the side edge surface of the glass pane, via the edge surface of a recess in the glass pane or by using a light incoupling means via one of the surfaces (main surfaces) of the glass pane. The light is radiated into the glass pane and propagates (at least) in the glass pane, the light undergoing total reflection at the above-described interfaces to an optically less dense medium (in particular the surfaces of the glass pane). More precisely, those portions of the light that strike the surfaces in question at an angle of incidence that is greater than the relevant critical angle of total reflection are totally reflected. Since there is a transition from an optically denser to an optically less dense medium, a critical angle at of the total reflection can be determined as

$${α}_{T} = arcsin ( \frac{{n}_{2}}{{n}_{1}} ) ,$$

where n₁ is the refractive index of the glass pane and n₂ is the refractive index of the adjacent medium.

In certain embodiments of the invention, the medium adjacent to the first surface of the transparent layer is different from the medium adjacent to the second surface. This is the case with laminated panes, for example, which consist of two laminated glass panes, wherein one of the glass panes is used as a transparent layer. Then, one of the surfaces of said glass pane is adjacent to the surrounding atmosphere and the other surface is adjacent to the thermoplastic intermediate layer of the laminated pane. Therefore, different critical angles of total reflection occur on the two surfaces. In this case, the portion of light that propagates in the glass pane is that which strikes the surfaces at an angle of incidence that is greater than the larger critical angle of total reflection.

The refractive index and the critical angle of total reflection also depend in this case on the wavelength of the light from the light source. For example, at a wavelength of 589 nm, the refractive index of a pane of soda lime glass is 1.52. If the interface is an exposed surface of the glass pane and the adjacent medium is the surrounding atmosphere (in particular air: refractive index 1.00 at a light wavelength of 589 nm), the critical angle of total reflection is α_{T}=41°. If the interface is a surface of the glass pane facing the intermediate layer of a laminated pane in the form of a PVB film (refractive index 1.48 at a light wavelength of 589 nm), the critical angle of total reflection is α_{T}=77°. As is conventional in geometrical optics, the angle of incidence is the angle between the light beam incident on the surface and the surface normal of the surface at the point of impact. The critical angle of total reflection is also determined analogously to the surface normal.

During operation, the light source emits visible light, i.e. electromagnetic radiation in the visible spectral range, in particular in the range from 380 nm to 780 nm. The light source can have one or more emission bands, which is or are arranged in the visible spectral range and covers or cover a part thereof. However, the light source can also have a broad emission band that covers the entire visible spectral range. The emission band(s)—and thus the colour of the emitted light—can be freely selected according to the requirements of the specific application.

The glazing element can have a single light source or a plurality of light sources whose light is coupled into the glass pane at different points. The light from the light source can be radiated into the glass pane directly or via an optical element, such as a lens or a collimator.

The light source is preferably a light-emitting diode (LED). The electroluminescent material of the light-emitting diode can be an inorganic semiconductor or an organic semiconductor, for example. In the latter case, it is also referred to as an organic light emitting diode (OLED).

The coupling of the light from the light source into the glass pane can be carried out in different ways, with three embodiments being particularly preferred.

In a first preferred embodiment, the light source is associated with one of the two surfaces (main surfaces) of the glass pane. The light source is arranged on one of the surfaces and radiates light via this surface into the glass pane. The glazing element is equipped, opposite the light source, with a light incoupling means which is irradiated with light from the light source through the glass pane. The light incoupling means is suitable for coupling the light into the glass pane via the surface facing away from the light source and facing the light incoupling means, so that at least a portion of the light propagates (at least) in the glass pane by total reflection. For this purpose, the light incoupling means typically has reflective surfaces that are suitably inclined relative to the surface of the glass pane. The light incoupling means can be, for example, in the form of a microprism film, a structured plastic film or a plastic plate with a planar arrangement of microprisms. The light incoupling means reflects the light back into the glass pane, but at a modified angle that deviates from 0° to the surface normal. The light is refracted at the surface of the glass pane and at least some of the resulting light in the glass pane strikes the opposite surface at an angle of incidence that is greater than the critical angle of total reflection, as a result of which the light is coupled into the glass pane.

The light source is preferably arranged on an exposed surface of the glass pane or glazing element so that the light source can be subsequently attached and easily replaced in the event of a defect. Particularly preferred is the interior-side exposed surface of the glass pane or glazing element, which is preferably also provided with the emissivity-reducing coating (second surface of the glass pane). The light incoupling means is preferably arranged on the first surface of the glass pane

In a second preferred embodiment, the light source is associated with a recess in the glass pane. The glass pane therefore has a recess. This recess is preferably a hole, i.e. a passage which extends between the first and the second surface of the glass pane. Alternatively, however, the recess can also be a depression in the form of a blind hole (pouch-like depression) which extends from the first surface or the second surface into the glass pane but without reaching the opposite main surface, which would result in a passage. The blind hole preferably extends from a surface which forms an exposed surface of the glass element according to the invention into the glass pane. The light source can then be installed subsequently and be easily replaced in the event of a defect. In the case of a laminated pane, the surface of the glass pane that faces away from the intermediate layer is the exposed surface. The recess can be created, for example, by mechanical drilling or by laser beam machining in the glass pane. The recess is preferably round, but can in principle have any shape, for example a polygonal shape. This refers to the base of the recess in the plane of the at least one surface of the glass pane via which the recess is made in the glass pane.

The recess, whether in the form of a passage or a depression, is limited by a peripheral edge surface which extends between the main surfaces of the glass pane. In the case of a passage, this is the only boundary surface of the recess. In the case of a pouch-like depression, there is a further boundary surface facing the main surface of the glass pane, to which the depression does not extend, and forming, as it were, the bottom of the blind hole. If the glazing element comprises a plurality of light sources, a separate recess is preferably provided for each light source.

In this embodiment, the light source is associated with said edge surface of the recess and is suitable for coupling light into the glass pane via this edge surface. The light source itself can be arranged in the recess so that it is located in the plane defined by the glass pane and the emitted light strikes the edge surface directly. For example, the light source can be clamped into the recess or glued to the edge surface. It is also conceivable for the light source to be located in a housing or a holder where it is fixed in place, the housing or the holder being inserted into the recess, preferably with a precise fit. Alternatively, however, it is also possible for the light source not to irradiate the edge surface directly, but for the radiation to first be deflected. It is conceivable for the light source to be located in a housing, with one part of the housing being inserted into the recess, while another part of the housing is located outside the recess. The light source is positioned in the part of the housing outside the recess and the light is deflected by reflective surfaces or waveguides in the housing in such a way that it irradiates the edge surface of the recess. Said housing is preferably attached to an exposed surface of the glass pane and extends from there into the recess.

In a third preferred embodiment, the light source is associated with the side edge surface of the glass pane and is suitable for coupling light into the glass pane via the side edge surface. The light emitted by the light source can strike the side edge surface directly. The light source can be located to the side of the glass pane in the plane defined by the glass pane. For this purpose, the light source can be attached directly to the side edge surface, for example by gluing or clamping. Alternatively, the light source can also be located in a housing or a holder where it is fixed in place, the housing or the holder being attached, for example glued or clamped, to the glass pane in such a way that the light source irradiates the side edge surface. However, it is also possible for the light source not to irradiate the side edge surface directly, but for the radiation to first be deflected. It is conceivable for the light source to be located in a housing that contains reflective surfaces or waveguides through which the beam path of the light is shaped. This housing is attached to the glass pane in such a way that the beam path directs the light to the side edge surface of the glass pane. The light source itself then does not have to be located to the side of the glass pane in the plane defined by the glass pane, but can be arranged, for example, in front of or behind the glass pane in the viewing direction. Said housing is preferably attached to an exposed surface of the glass pane and extends from there to the side edge surface of the glass pane.

A combination of the embodiments described above is also conceivable, with a plurality of light sources being present whose light is coupled into the glass pane in different ways.

The glazing element (in particular the glass pane) is also provided with a light-scattering structure which is suitable for decoupling the coupled-in light from the glass pane via the first and/or the second surface. The light-scattering structure is arranged on one of the two totally reflective interfaces or between them.

The light-scattering structure preferably has direct contact with one of the surfaces of the glass pane so that the light propagating in the glass pane strikes it. The light-scattering properties of the light-scattering structure prevent total reflection. The light-scattering structure represents, as it were, a scattering centre at which the light is scattered and therefore not totally reflected. Since the scattering is in principle undirected, at least some of the scattered light leaves the glass pane. In this way, illumination can be realised or information or aesthetic forms can be presented.

The surface of the glazing element covered by the light-scattering structure appears to the observer as a luminous surface. This can be used, for example, for illumination (for example of an interior) or for realising a display to present information or aesthetic forms. The luminous structure can be present in a single continuous region of the glazing element or in a plurality of separate regions. Any shape or pattern can be realised by the light-scattering structure.

The light-scattering structure can be applied directly to the first or second surface of the glass pane or formed there. Alternatively, the light-scattering structure can be provided, for example, on a carrier foil that is fastened to the first or second surface, for example by adhesive bonding. If the glass element according to the invention is a laminated pane, the light-scattering structure can be applied to the surface of the thermoplastic intermediate layer in contact with the glass pane. Alternatively, the light-scattering structure (applied to a carrier foil, for example) can be inserted between the glass pane and the intermediate layer.

In an advantageous embodiment, the light-scattering structure is in the form of an imprint, in particular an imprint on one of the surfaces of the glass pane or—in the case of a laminated pane—on the surface of the intermediate layer facing the glass pane. An imprint on the glass pane is preferably in the form of a light-scattering enamel. This enamel can, for example, be applied using a screen printing method. It preferably contains glass frits, which are burned into the surface of the glass pane, producing a roughened and therefore light-scattering surface. An imprint on the intermediate layer can be realised by printing a light-scattering printing paste onto a surface of a thermoplastic film, for example using a screen printing method. During the manufacture of the laminated pane, the film is inserted between the outer and inner pane to form the intermediate layer, with the printed-on surface facing the glass pane, in particular in direct contact with the glass pane. In an advantageous embodiment, the light-scattering structure is transparent so that it does not substantially restrict visibility through the glazing element. The imprint (the enamel or printing paste) therefore preferably contains no pigment. However, opaque or semi-transparent light-scattering structures with pigments, for example white structures, are also conceivable.

However, light-scattering structures can also be formed by roughening the relevant surface of the glass pane, or the intermediate layer. This roughening can be carried out mechanically (e.g. by grinding techniques) or by laser beam machining. The advantage of laser beam machining, in particular in the case of a laminated pane, is that the light-scattering structure can also be introduced into the finished laminated pane, even if it is to be located inside the laminated pane, since the laser radiation can also be focused on a plane inside the laminated pane, for example through the transparent glass pane. Laser beam machining also makes it possible to form the light-scattering structure inside the glass pane rather than on the surface.

The glass pane is preferably made of soda lime glass, which is conventional for window panes. In principle, however, the glass pane can also be made of other types of glass (e.g. borosilicate glass, quartz glass, aluminosilicate glass). In a preferred embodiment, glass compositions with a transmission in the visible range of the light spectrum of greater than 90% are used. The thickness of the glass pane can vary widely. Preferably, panes with a thickness in the range of 0.5 mm to 10 mm and preferably of 1 mm to 5 mm are used. In the case of a laminated pane, the same applies to the further pane, it being possible for the material and thickness of the further pane and the glass pane to be selected independently of each other.

The glass pane is preferably clear so that the light can propagate advantageously in the glass pane. In the case of a laminated pane, the further pane and the intermediate layer can be clear or tinted or coloured. In particular in the case where the glazing element comprises the laminated pane and is used as a roof window in a vehicle, the laminated pane can comprise a tinted intermediate layer and/or a tinted further pane. Particularly if the glass pane is the inner pane of the laminated pane, facing the vehicle interior, and the further pane is the outer pane, facing the external environment, this can enable both a high light intensity and a colour-neutral display, with the tinted intermediate layer or the tinted outer pane increasing thermal comfort, particularly in strong sunlight, and preventing the vehicle occupants from being dazzled. The tinted outer pane, or the tinted intermediate layer, preferably has a visible light transmittance of less than 50%, particularly preferably less than 20%.

The thermoplastic intermediate layer comprises at least one layer of a thermoplastic compound material, which preferably contains ethylene vinyl acetate (EVA), polyvinyl butyral (PVB) or polyurethane (PU), or mixtures, or copolymers, or derivatives thereof, particularly preferably PVB. The intermediate layer is typically formed from at least one thermoplastic film. The thickness of the film is preferably from 0.3 mm to 2 mm, with the standard thicknesses of 0.36 mm and 0.76 mm being particularly common. The intermediate layer can also comprise a plurality of layers of thermoplastic material and can be formed, for example, from a plurality of polymer films arranged flat on top of one another.

The glazing element preferably has an opaque masking region through which it is not possible to see. This masking region is preferably arranged peripherally in an edge region and surrounds a central transparent see-through region in the manner of a frame. This is particularly common for vehicle windows. The masking region is preferably formed by an opaque cover print on the glass pane and/or (in the case of a laminated pane) on the further pane. The cover print is typically made of an enamel which contains glass frits and a pigment and is preferably applied using the screen printing method and then burnt in. In an alternative embodiment, the cover print is applied using a digital printing method and then burnt in.

The invention also comprises a method for producing an illuminated glazing element according to the invention, wherein
(a) a glass pane is provided having a first surface and a second surface,
(b) the second surface of the glass pane is provided with an emissivity-reducing coating which has exactly one electrically conductive layer based on a transparent conductive oxide and the electrically conductive layer has, within the wavelength range from 380 nm to 780 nm, an imaginary component k of the refractive index, for which k<0.035 applies,
(c) the glass pane is equipped with at least one light source which is suitable for coupling light into the glass pane in such a way that the light propagates in the glass pane, in particular by total reflection at the first surface and the second surface.

The glazing element is provided with at least one light-scattering structure which is suitable for decoupling said light from the glass pane via the first surface and/or via the second surface. This can be done between method steps (a) and (b), between method steps (b) and (c) or after method step (c).

The emissivity-reducing coating is preferably deposited on the substrate surface by vapour deposition, for example by chemical vapour deposition (CVD), plasma-enhanced chemical vapour deposition (PECVD) or atomic layer deposition (ALD). Physical vapour deposition (PVD), for example evaporation deposition, is particularly preferred, cathode sputtering (“sputtering”) and in particular magnetic field-assisted cathode sputtering (“magnetron sputtering”) are very particularly preferred.

In a preferred embodiment of the method according to the invention, the emissivity-reducing coating is deposited by vapour deposition, in particular by magnetic-field-assisted cathode sputtering. An electrically conductive layer according to the invention with an imaginary component k of the refractive index of less than 0.035 can be realised in particular by adding a proportion of 1 volume % to 3 volume % of oxygen to the process gas. The electrically conductive layer is preferably deposited by magnetic-field-assisted cathode sputtering in DC mode, with the glass pane preferably not being actively heated.

Preferably, the emissivity-reducing coating is subjected to a thermal post-treatment after deposition. Such methods for thermally tempering conductive coatings are known in principle to a person skilled in the art. The inventors have found that thermally treating the emissivity-reducing coating makes it easier to achieve the refractive indices according to the invention.

If the glass element is a laminated pane, the glass pane is connected to a further pane via a thermoplastic intermediate layer. Then it is also possible for the light-scattering structure and either the light-scattering or light-diffracting layer or the opaque element not to be applied to the glass pane, but to be applied to the intermediate layer or to be inserted between the intermediate layer and the glass pane, as already described above. The light source is preferably installed after the lamination of the laminated pane.

Methods for lamination that are known per se can be used, for example autoclave methods, vacuum bag methods, vacuum ring methods, calendering methods, vacuum laminators, or combinations thereof. The outer pane and inner pane are usually connected under the effect of heat, vacuum and/or pressure.

The invention also comprises the use of a glazing element according to the invention as a window pane of a vehicle. A particularly preferred use is a vehicle roof window. In principle, the vehicle can be any land vehicle, watercraft or aircraft, and is preferably a passenger car, truck or rail vehicle. The glazing element can also be used in buildings, for example as a window pane, glass façade or glass door in exterior or interior areas, in particular as a window pane of a building or an interior. The glazing element can also be used as a component of furniture, electrical appliances, as a component of furnishings or as a furnishing item.

In the following, the invention is explained in more detail with the aid of a drawing and examples of embodiments. The drawing is a schematic representation and is not true to scale. The drawing does not limit the invention in any way.

In the drawings:

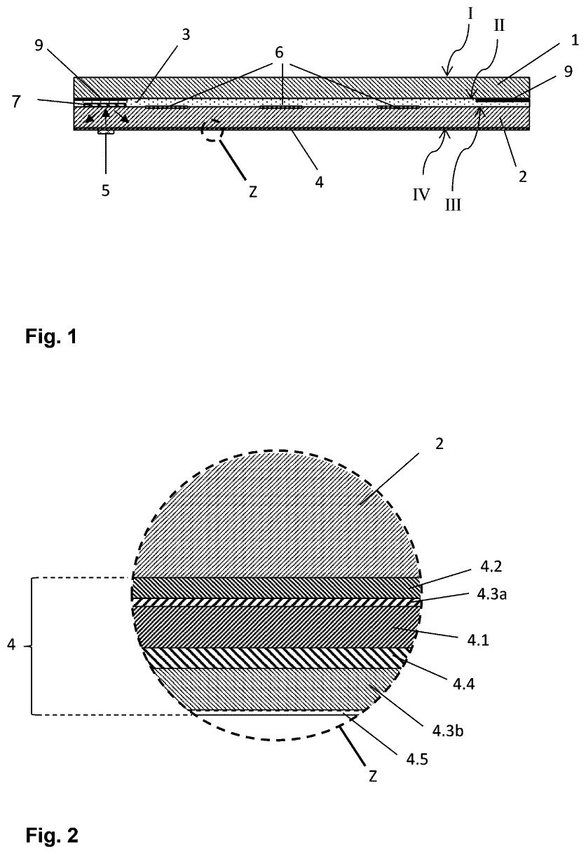

FIG. 1 is a cross-section through a first embodiment of the glazing element according to the invention,

FIG. 2 is an enlarged representation of the portion Z from FIG. 1,

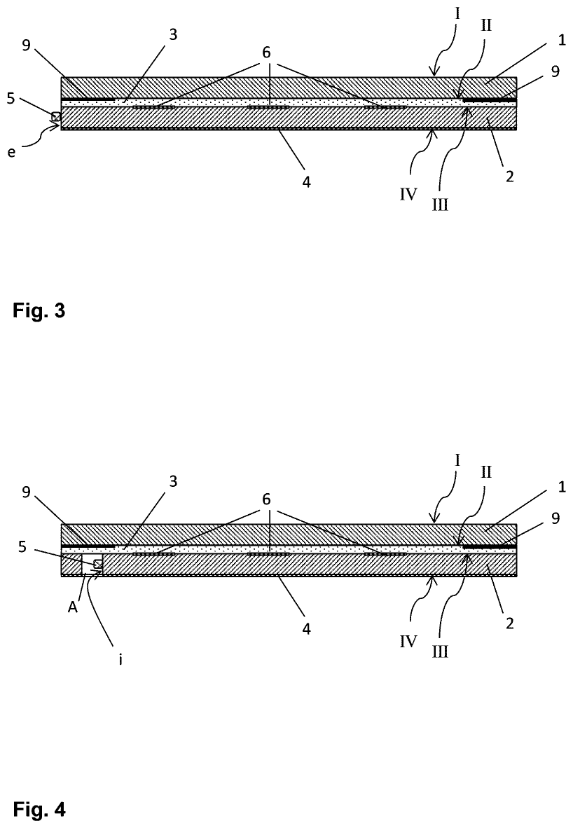

FIG. 3 is a cross-section through a further embodiment of the glazing element according to the invention,

FIG. 4 is a cross-section through a further embodiment of the glazing element according to the invention,

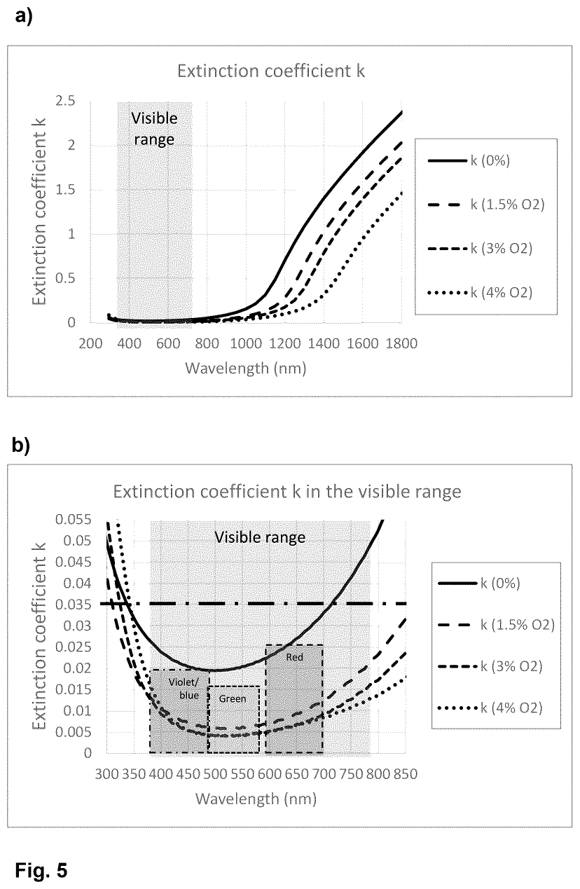

FIG. 5 shows graphs of the extinction coefficient k (imaginary part of the complex refractive index) for conventional ITO layers according to the invention,

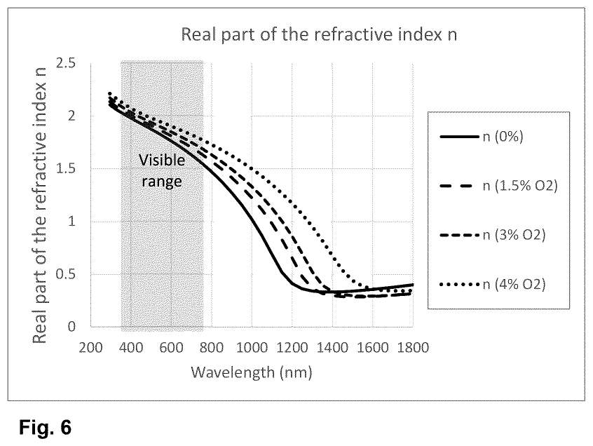

FIG. 6 is a graph of the real part of the complex refractive index n for the conventional ITO layers according to the invention from FIG. 5

FIG. 1 and FIG. 2 each show a detail of a first embodiment of the glazing element according to the invention. The glass element is in the form of a laminated pane, which comprises a glass pane 2 as an inner pane, which is connected to an outer pane 1 via a thermoplastic intermediate layer 3. The outer pane 1 and the glass pane 2 consist, for example, of soda lime glass and each have, for example, a thickness of 2.1 mm. The intermediate layer 3 is formed, for example, from a PVB foil with a thickness of 0.76 mm. The glazing element is shown flat, but can also be cylindrical or spherically curved depending on the intended use. The glazing element is intended, for example, as a roof window of a passenger car.

In the installed position, the outer pane 1 faces the external environment; the glass pane 2 faces the vehicle interior. The outer pane 1 has an outer surface I which faces the external environment, and an interior-side surface II which faces the vehicle interior. Likewise, the glass pane 2 has two parallel main surfaces, specifically a first surface III, which constitutes the outer surface, and a second surface IV, which constitutes the interior-side surface.

The glass pane 2 acts as a light-conducting layer of the illuminated glazing element. A light source 5 is attached to the second (interior-side) surface IV of the glass pane 2. Opposite the light source 5, a light incoupling means 7 is attached to the first (outer) surface Ill of the glass pane 2. The light source 5 irradiates the light incoupling means 7 through the glass pane 2. The light source 5 is in the form of a light-emitting diode. The light incoupling means 7 is in the form of a microprism film having a plurality of reflection surfaces which are inclined with respect to the surfaces III, IV. The reflected light then re-enters the glass pane 2 via the first surface III at a changed beam angle. The light is thus coupled into the glass pane 2 via the first surface Ill by means of the light incoupling means 7. The light radiation is indicated by arrows in the figure. A portion of the light strikes the surfaces III, IV of the glass pane 2 at an angle of incidence which is greater than the critical angle of total reflection (or greater than the largest critical angle of total reflection, since different critical angles of total reflection occur at the two surfaces III, IV due to the different adjacent medium). This light portion propagates through repeated total reflection in the glass pane 2.

In a peripheral edge region of the glazing element, an opaque cover print 9 is applied to the interior-side surface II of the outer pane 1. The light source 5 and light incoupling means 7 are arranged inconspicuously in this opaque edge region (masking region).

The first surface III of the glass pane 2 is provided with a plurality of light-scattering structures 6, at which the light is scattered and total reflection is prevented. Thus, the light is decoupled from the glass pane 2, in particular via the second surface IV, so that the vehicle occupants perceive the surfaces having the light-scattering structures 6 as luminous surfaces.

The second (interior-side) surface IV of the glass pane 2 is provided with an emissivity-reducing coating 4, the optical properties of which are optimised to such an extent that it does not lead to a significant loss of intensity of the propagating light and does not lead to a change in its colour. The emissivity-reducing coating 4 is in the form of a stack of thin layers. The individual layers can be seen in the enlarged view of FIG. 2.

The emissivity-reducing coating 4 consists of a lower dielectric blocking layer 4.2, a lower dielectric anti-reflective layer 4.3a, an electrically conductive layer 4.1, an upper dielectric barrier layer 4.4, an upper dielectric anti-reflective layer 4.3b and a scratch protection layer 4.5. The lower dielectric blocking layer 4.2 has a refractive index of at least 1.9 and prevents the diffusion of alkali ions from the glass pane 2 into the layers above the blocking layer 4.2. The lower dielectric anti-reflective layer 4.3a has a refractive index of at most 1.6; the upper dielectric anti-reflective layer 4.3b has a refractive index of at most 1.8. The anti-reflective layers 4.3a, 4.3b increase the transmittance through the pane and reduce the reflectivity. The upper dielectric barrier layer 4.4 regulates oxygen diffusion into the layer stack and has a refractive index of at least 1.9. The electrically conductive layer 4.1 consists of ITO and has, within the wavelength range from 380 nm to 780 nm, an imaginary component k of the refractive index, for which k<0.035 applies.

FIG. 3 shows a further embodiment of the glazing element according to the invention. The glazing element is in principle of the same design as in the embodiment in FIG. 1, but differs in the type of light incoupling. The light source 5 is attached to the side edge surface e of the glass pane 2 and radiates the light via this side edge surface e into the glass pane 2. Here again, a portion of the light strikes the surfaces III, IV of the glass pane 2 at an angle of incidence which is larger than the (largest) critical angle of total reflection and propagates through repeated total reflection in the glass pane 2.

For the sake of simplicity, the side edge surface e is shown flat, but in reality is often convexly rounded as a result of edge grinding.

FIG. 4 shows a further embodiment of the glazing element according to the invention. The glazing element is in principle of the same design as in the embodiment in FIGS. 1 and 3, but differs in turn in the type of light incoupling. The glass pane 2 is provided with a recess A, which extends as a passage completely through the glass pane 2, i.e. from its first surface III to its second surface IV. This recess A has, for example, a circular base and is bordered by a peripheral edge surface i. The light source 5 is inserted into the recess A, for example glued to the edge surface i. The light is coupled into the glass pane 2 via the edge surface i. Here again, a portion of the light strikes the surfaces III, IV of the glass pane 2 at an angle of incidence which is larger than the (largest) critical angle of total reflection and propagates through repeated total reflection in the glass pane 2.

In the following, the structure of the emissivity-reducing coating is explained using examples and comparative examples according to the invention. The layer structures shown are to be understood only as examples. For example, the dielectric layer sequences can also comprise more or fewer layers. The dielectric layer sequences also do not have to be symmetrical. Exemplary materials and layer thicknesses can be found in the following examples. The emissivity-reducing coatings are applied to the second surface IV of the glass pane 2 and are located adjacent to the vehicle interior when the glazing element is installed in a vehicle.

The layer sequences of an emissivity-reducing coating 4 on a glass pane 2 according to examples B1 to B6 according to the invention, together with the materials and geometric layer thicknesses of the individual layers, are shown in Table 1. The dielectric layers can be doped independently of one another, for example with boron, titanium, zirconium or aluminium. The electrically conductive layer 4.1 provided as an ITO layer is deposited with an oxygen content according to Table 1 in the process gas by means of magnetic-field-assisted cathode sputtering. Magnetic-field-assisted cathode sputtering is carried out, for example, in an industrial plant in direct current mode (DC mode) without active heating of the glass pane 2 during deposition. Each glass pane 2 has a thickness of 2.0 mm and consists of soda lime glass. Examples B1 to B3 and B4 to B6 each have identical layer stacks, in the first case with a thin TiOₓ top layer as a scratch protection layer 4.5 and in the second case without such a scratch protection layer 4.5. Examples B1 to B3 and B4 to B6 differ from each other in the oxygen content during the deposition of the ITO layer.

Table 2 shows further examples B7 to B12 according to the invention. Examples B7 to B9 and B10 to B12 differ from each other in the oxygen content during the deposition of the ITO layer. Here, layer variants with thicker ITO are considered. Table 3 shows comparative examples V1 to V4 not according to the invention, in which an emissivity-reducing coating 4 according to the comparative examples has the identical basic structure as in the examples according to the invention, but differs in the layer thicknesses and in the oxygen content of the process gas during the deposition of the electrically conductive layer 4.1 (ITO). The structure of the emissivity-reducing coating 4 in comparative example V1 corresponds to the layer structure of the emissivity-reducing coating 4 in examples B1, B2 and B3, the difference being that in V1 the oxygen content in the process gas is 0% when the ITO layer is deposited. Likewise, the layer structure of the emissivity-reducing coating 4 in comparative example V2 corresponds to the layer structure of B4, B5 and B6, the layer structure in V3 to that of B7, B8 and B9 and the layer structure in V4 to that of B10, B11 and B12, the difference in each case being that in comparative examples V2, V3 and V4 the oxygen content in the process gas is 0% when the ITO layer is deposited.

TABLE 1

| | Reference | Layer thicknesses | | | | | |
|---|---|---|---|---|---|---|---|
| Material | sign | B1 | B2 | B3 | B4 | B5 | B6 |

| | | | |
|---|---|---|---|
| TiOₓ | 4.5 | — | 2 nm |
| SiO₂ | 4.3b | 50 nm | 50 nm |
| Si₃N₄ | 4.4 | 13 nm | 13 nm |
| ITO | 4.1 | 67 nm | 67 nm |
| SiO₂ | 4.3a | 15 nm | 15 nm |
| Si₃N₄ | 4.2 | 27 nm | 27 nm |
| Glass | 2 | 2.0 mm | 2.0 mm |

| | | | | | | |
|---|---|---|---|---|---|---|
| Oxygen content of | 1.5% | 3% | 4% | 1.5% | 3% | 4% |
| process gas ITO | | | | | | |

TABLE 2

| | Reference | Layer thicknesses | | | | | |
|---|---|---|---|---|---|---|---|
| Material | sign | B7 | B8 | B9 | B10 | B11 | B12 |

| | | | |
|---|---|---|---|
| TiOₓ | 4.5 | — | — |
| SiO₂ | 4.3b | 66 nm | 65 nm |
| Si₃N₄ | 4.4 | 20 nm | 15 nm |
| ITO | 4.1 | 85 nm | 100 nm |
| SiO₂ | 4.3a | 5 nm | 10 nm |
| Si₃N₄ | 4.2 | 22 nm | 15 nm |
| Glass | 2 | 2.0 mm | 2.0 mm |

| | | | | | | |
|---|---|---|---|---|---|---|
| Oxygen content of | 1.5% | 3% | 4% | 1.5% | 3% | 4% |
| process gas ITO | | | | | | |

TABLE 3

| | Reference | Layer thicknesses | | | |
|---|---|---|---|---|---|
| Material | sign | V1 | V2 | V3 | V4 |
| TiOₓ | 4.5 | | 2 nm | | |
| SiO₂ | 4.3b | 50 nm | 50 nm | 66 nm | 65 nm |
| Si₃N₄ | 4.4 | 13 nm | 13 nm | 20 nm | 15 nm |
| ITO | 4.1 | 67 nm | 67 nm | 85 nm | 100 nm |
| SiO₂ | 4.3a | 15 nm | 15 nm | 5 nm | 10 nm |
| Si₃N₄ | 4.2 | 27 nm | 27 nm | 22 nm | 15 nm |
| Glass | 2 | 2.0 mm | 2.0 mm | 2.0 mm | 2.0 mm |

| | | | | |
|---|---|---|---|---|
| Oxygen content of | 0% | 0% | 0% | 0% |
| process gas ITO | | | | |

Table 4 indicates the maximum extinction coefficient kₘₐₓ of the electrically conductive layer 4.1 in the wavelength range of visible light from 380 nm to 780 nm for different oxygen contents in the process gas of ITO. In the examples B1 to B12 according to the invention, the electrically conductive layer 4.1 has, in the wavelength range of visible light, maximum extinction coefficients kₘₐₓ of 0.021, 0.015 and 0.016, which are thus smaller than 0.035, which is a prerequisite for an example according to the invention. In addition, the maximum extinction coefficient k of the electrically conductive layer 4.1 is indicated in the wavelength ranges from 380 nm to 490 nm, from 490 nm to 575 nm and from 600 nm to 700 nm. The examples according to the invention have maximum extinction coefficients k of less than 0.020 in the wavelength range from 380 nm to 490 nm, of less than 0.015 in the wavelength range from 490 nm to 575 nm and of less than 0.025 in the wavelength range from 600 nm to 700 nm. The comparative examples each have an extinction coefficient k above these values in the wavelength ranges specified.

In the comparative examples V1 to V4, the electrically conductive layer 4.1 has, in the wavelength range of visible light from 380 nm to 780 nm, a maximum extinction coefficient kₘₐₓ of 0.048, which is thus greater than 0.035, which is why the comparative examples are not in accordance with the invention.

TABLE 4

| Example | B1/B4/B7/B10 | B2/B5/B8/B11 | B3/B6/B9/B12 | V1/V2/V3/V4 |
|---|---|---|---|---|
| Oxygen content | 1.5% | 3% | 4% | 0% |
| of process gas | | | | |
| ITO | | | | |
| kₘₐₓ, (ITO, | 0.021 | 0.015 | 0.016 | 0.048 |
| 380 nm-780 nm) | | | | |
| kₘₐₓ (ITO, | 0.013 | 0.013 | 0.016 | 0.026 |
| 380 nm-490 nm) | | | | |
| kₘₐₓ (ITO, | 0.007 | 0.005 | 0.005 | 0.021 |
| 490 nm-575 nm) | | | | |
| kₘₐₓ (ITO, | 0.013 | 0.009 | 0.008 | 0.033 |
| 600 nm-700 nm) | | | | |

Table 5 summarises some characterising parameters of the examples B1 to B3 according to the invention in comparison with the comparative example V1. The reflectance R_{L} and the colour values a and b* of the reflected light, in each case using the standard light source D65 with a 10° detector for the reflection below 8° at the emissivity-reducing coating as seen from the vehicle interior (referred to as R_{L(coating)}, a*_{coating}, b*_{coating}) and for the reflection within the glass at the interface of the coating below 80° (denoted as R_{L(interface)}, a*_{interface}, b*_{interface}). The presented values of the reflectance R_{L} and the colour values a* and b* were determined by simulations using the CODE software. The reflection angles specified are given in relation to the relevant surface normal.

R_{L} is a measure of the reflectivity with respect to light radiation and should be as low as possible for R_{L(coating)} to avoid undesired reflections inside the vehicle, whereas R_{L(interface)} is to be maximised with a view to optimising the light intensity of the illuminated glazing element. The colour values in the L*a*b* colour spectrum are a measure of how colour-neutral the light reflection is; the values should be as close as possible to zero.

For examples B1 to B3 and comparative example V1, the sheet resistance and emissivity after heat treatment were additionally determined and are indicated in Table 5. Low values for sheet resistance and emissivity enable greater thermal comfort. Examples B1 and B2 are therefore preferred because they have high light reflection in the glass and low emissivity.

TABLE 5

| Parameters for | | | | | |
|---|---|---|---|---|---|
| single pane | | B1 | B2 | B3 | V1 |
| Reflection of | R_{L(coating)} | 6.9 | 6.9 | 6.9 | 6.6 |
| low-E coating | (%) | | | | |
| below 8° | a*_{coating} | 2.1 | 2.6 | 3.3 | 1.5 |
| interior-side | b*_{coating} | −8.9 | −7.7 | −6.1 | −10 |
| Reflection at | R_{L(interface)} | 96.7 | 97.9 | 98.2 | 88.0 |
| interface | (%) | | | | |
| between glass and | a*_{interface} | −1.4 | −1.0 | −0.8 | −4.2 |
| low-E coating | b*_{interface} | −0.9 | −0.4 | −0.3 | −4.2 |
| below 80° | | | | | |
| Sheet resistance | | 23.8 | 26.8 | 32.4 | 30.3 |
| [Ω/sq.] | | | | | |
| after heat treatment | | | | | |
| Emissivity after heat | | 25.9% | 26.4% | 30.8% | 27.9% |
| treatment | | | | | |

Table 6 and Table 7 show the reflection properties of the coating both from the outside (coating) and from the inside (interface) for examples B4 to B12 according to the invention and comparative examples V2 to V4.

All examples according to the invention have an optimised light intensity of the illuminated glazing element, it being possible to achieve R_{L(interface)} above 96% and colour values a*_{interface} and b*_{interface} between −1.7 and 0.0. At the same time, the reflectivity R_{L(coating)} of the coating with less than or equal to 7% for a clear glass is classified as low. The reflection colour a*_{coating} and b*_{coating} are also within acceptable ranges for the customer. The colour values a*_{interface} and b*_{interface} are significantly more neutral for the examples according to the invention. This is important for light guidance without colour shift.

TABLE 6

| Parameters for single pane | | B4 | B5 | B6 | B7 | B8 | B9 |
|---|---|---|---|---|---|---|---|
| Reflection of low-E | R_{L(coating)} (%) | 6.5 | 6.4 | 6.2 | 7.0 | 6.7 | 6.3 |
| coating below 8° interior- | a*_{coating} | −0.1 | 0.5 | 1.4 | −4.2 | −4.2 | −4.3 |
| side | b*_{coating} | −6.5 | −5.5 | −4.1 | −4.4 | −4.7 | −5.2 |
| Reflection at interface | R_{L(interface)} (%) | 96.7 | 97.8 | 98.1 | 97.4 | 98.4 | 98.7 |
| between glass and low-E | a*_{interface} | −1.5 | −1.0 | −0.8 | −1.3 | −0.8 | −0.6 |
| coating below 80° | b*_{interface} | −0.9 | −0.5 | −0.3 | −0.5 | −0.2 | 0.0 |

TABLE 7

| Parameters for single pane | | B10 | B11 | B12 | V2 | V3 | V4 |
|---|---|---|---|---|---|---|---|
| Reflection of low-E | R_{L(coating)} (%) | 6.8 | 6.6 | 6.3 | 6.4 | 7.2 | 7.0 |
| coating below 8° interior- | a*_{coating} | −3.5 | −3.7 | −4.1 | −0.9 | −4.5 | −3.7 |
| side | b*_{coating} | −1.9 | −2.5 | −3.2 | −7.4 | −3.8 | −0.9 |
| Reflection at interface | R_{L(interface)} (%) | 96.9 | 98.1 | 98.4 | 88.3 | 90.3 | 87.9 |
| between glass and low-E | a*_{interface} | −1.7 | −1.0 | −0.7 | −4.2 | −4.4 | −6.1 |
| coating below 80° | b*_{interface} | −0.7 | −0.2 | 0.0 | −4.0 | −3.1 | −4.1 |

It should be noted that the reflectivity values and colour values depend on the tint level of the pane and may differ between a single pane and a laminated pane. While Tables 5 to 7 investigated a single extra-clear glass pane, Table 8 considers a laminated pane. The laminated pane comprises the glass pane 2 made of extra-clear glass with the emissivity-reducing coating 4 from examples B1, B2 and B3 according to the invention and comparative example V1, and an outer pane 1, also made of extra-clear glass, which is connected to the glass pane 2 via a thermoplastic intermediate layer 3, the thermoplastic intermediate layer 3 being made of polyvinyl butyral (PVB) and being heavily tinted. Heavily tinted means that the transmittance of visible light through the laminated pane is reduced to, for example, approx. 6%, while with the single pane a transmittance of visible light of, for example, approx. 92% is achieved, the transmittance of visible light meaning the average transmittance in a wavelength range of from 380 nm to 780 nm. This is particularly advantageous when a glazing element comprising the laminated pane is used as a roof window in a vehicle. The use of a tinted laminated pane instead of a single pane has a major effect on the reflection properties of the layer when viewed from the outside (“coating”), but does not affect the reflection properties within the glass (“interface”), which in turn determine the light guidance.

TABLE 8

| Parameters for | | | | | |
|---|---|---|---|---|---|
| laminated | | | | | |
| pane with tinted | | | | | |
| intermediate layer | | B1 | B2 | B3 | V1 |
| Reflection of | R_{L(coating)} | 3.6 | 3.6 | 3.6 | 3.4 |
| low-E coating | (%) | | | | |
| below 8° | a*_{coating} | 3.5 | 4.2 | 5.3 | 2.4 |
| interior-side | b*_{coating} | −13.6 | −12.0 | −9.6 | −15.3 |
| Reflection at | R_{L(interface)} | 96.7 | 97.9 | 98.2 | 88.0 |
| interface between | (%) | | | | |
| glass and low-E | a*_{interface} | −1.4 | −1.0 | −0.8 | −4.2 |
| coating below 80° | b*_{interface} | −0.9 | −0.4 | −0.3 | −4.2 |

FIG. 5 shows the extinction coefficients k of a plurality of TCO layers as a function of the wavelength. The TCO layers are in the form of ITO layers which are deposited by means of magnetic-field-assisted cathode sputtering. No oxygen (0% O₂) was added to the process gas, as in comparative examples V1, V2, V3 and V4; 1.5% oxygen was added to the process gas, as in examples B1, B4, B7 and B10 according to the invention; 3% oxygen was added to the process gas, as in examples B2, B5, B8 and B11 according to the invention; and 4% oxygen was added to the process gas, as in examples B3, B6, B9 and B12 according to the invention. The extinction coefficient k is shown as a solid line for 0% oxygen, as a long-dashed line for 1.5% oxygen, as a short-dashed line for 3% oxygen and as a dotted line for 4% oxygen. According to the example according to the invention, the ITO layer has, within the wavelength range from 380 nm to 780 nm, an imaginary component k of the refractive index, for which k<0.035 applies. In FIG. 5b), the values from FIG. 5a) are shown in a more detailed view in the visible wavelength range from 380 nm to 780 nm. From FIG. 5b) it can be seen that the comparative examples with 0% oxygen content are not comparative examples according to the invention, since the extinction coefficient k is not less than 0.035 in the entire wavelength range. In the examples with 1.5%, 3% and 4% oxygen content, however, the extinction coefficient is less than 0.035 in the entire wavelength range from 380 nm to 780 nm. These are therefore examples according to the invention. It should be noted that these are only exemplary values that show that it is possible to influence the extinction coefficient k by means of the oxygen content in the process gas.

FIG. 6 shows a diagram of the real part of the refractive index n as a function of the wavelength for the ITO layers of the examples according to the invention and the comparative examples not according to the invention from FIG. 5. The refractive indices were each determined by means of ellipsometry.

### LIST OF REFERENCE SIGNS

(1) Outer pane
(2) Glass pane/inner pane
(3) Thermoplastic intermediate layer
(4) Emissivity-reducing coating
(4.1) Electrically conductive layer
(4.2) Lower dielectric blocking layer
(4.3) Anti-reflective layers
(4.3a) Lower dielectric anti-reflective layer
(4.3b) Upper dielectric anti-reflective layer
(4.4) Upper dielectric barrier layer
(4.5) Scratch protection layer
(5) Light source
(6) Light-scattering structure
(7) Light incoupling means
(9) Cover print
(I) Outer surface of the outer pane 1
(II) Interior-side surface of the outer pane 1
(III) First surface of the glass pane 2
(IV) Second surface of the glass pane 2
(A) Recess in the glass pane 2
(e) Side edge surface of the glass pane 2
(i) Edge surface of the recess A
Z Enlarged section

1. An illuminated glazing element, comprising a glass pane having a first surface and a second surface,
wherein the glazing element
is equipped with at least one light source which is suitable for coupling light into the glass pane in such a way that the light propagates in the glass pane,
is provided with at least one light-scattering structure which is suitable for decoupling said light from the glass pane via the first surface and/or via the second surface,
is provided with at least one emissivity-reducing coating on the second surface of the glass pane,
wherein the emissivity-reducing coating comprises exactly one electrically conductive layer based on a transparent conductive oxide and the electrically conductive layer has, within the wavelength range from 380 nm to 780 nm, an imaginary component k of the refractive index, for which k<0.035 applies.

2. The illuminated glazing element according to claim 1, wherein the electrically conductive layer is based on indium tin oxide (ITO), indium zinc mixed oxide (IZO), fluorine-doped tin oxide (FTO, SnO₂:F), aluminium-doped zinc oxide (AZO, ZnO:Al), gallium-doped zinc oxide (GZO, ZnO:Ga), antimony-doped tin oxide (ATO, SnO₂:Sb) and/or niobium-doped titanium oxide (TiO₂:Nb).

3. The illuminated glazing element according to claim 1, wherein the emissivity-reducing coating has a specific sheet resistance of less than 250 μΩ·cm.

4. The illuminated glazing element according to claim 1, wherein the electrically conductive layer has, within the wavelength range from 600 nm to 700 nm, an imaginary component k of the refractive index, for which k<0.025.

5. The illuminated glazing element according to claim 1, wherein the electrically conductive layer has a thickness of from 60 nm to 100 nm.

6. The illuminated glazing element according to claim 1, wherein the emissivity-reducing coating, starting from the glass pane, comprises
a lower dielectric blocking layer against ion diffusion with a refractive index of at least 1.9,
a lower dielectric anti-reflective layer with a refractive index of at most 1.6,
the electrically conductive layer,
an upper dielectric barrier layer for regulating oxygen diffusion with a refractive index of at least 1.9 and
an upper dielectric anti-reflective layer with a refractive index of at most 1.8.

7. The illuminated glazing element according to claim 6, wherein the lower dielectric blocking layer is based on silver.

8. The illuminated glazing element according to claim 6, wherein the lower dielectric anti-reflective layer is based on SiO₂.

9. The illuminated glazing element according to claim 6, wherein the upper dielectric barrier layer is based on silicon nitride.

10. The illuminated glazing element according to claim 6, wherein the upper dielectric anti-reflective layer is based on SiO₂.

11. The illuminated glazing element according to claim 1, wherein the glass pane is the inner pane of a laminated pane and is connected to an outer pane via a thermoplastic intermediate layer, and wherein the second surface of the glass pane faces away from the intermediate layer.

12. The illuminated glazing element according to claim 1, wherein the light source is arranged on one of the first and second surfaces, and the glazing element is provided with a light incoupling means opposite the light source, which light incoupling means is suitable for coupling in the light striking the light incoupling means through the glass pane into the glass pane.

13. The illuminated glazing element according to claim 1, wherein the glass pane has a recess which is delimited by a peripheral edge surface, and wherein the light source is arranged in or on the recess such that it is suitable for coupling light into the glass pane via the edge surface.

14. The illuminated glazing element according to claim 1, wherein the at least one light source is arranged on a side edge surface of the glass pane, which surface extends between the first surface and the second surface, such that the light source is suitable for coupling light into the glass pane via the side edge surface.

15. A method for producing an illuminated glazing element, the method comprising:
providing a glass pane having a first surface and a second surface,
providing the second surface of the glass pane with an emissivity-reducing coating which has exactly one electrically conductive layer based on a transparent conductive oxide and the electrically conductive layer has, within the wavelength range from 380 nm to 780 nm, an imaginary component k of the refractive index, for which k<0.035 applies,
equipping the glass pane with at least one light source which is suitable for coupling light into the glass pane in such a way that the light propagates in the glass pane,
wherein the glazing element is provided with at least one light-scattering structure which is suitable for decoupling said light from the glass pane via the first surface and/or via the second surface.

16. The illuminated glazing according to claim 1, wherein the light propagates in the glass pane by total reflection at the first surface and the second surface.

17. The illuminated glazing element according to claim 2, wherein the electrically conductive layer is based on indium tin oxide (ITO).

18. The illuminated glazing element according to claim 3, wherein the specific sheet resistance is less than 200 μΩ·cm.

19. The illuminated glazing element according to claim 4, wherein k<0.020.

20. The illuminated glazing element according to claim 5, wherein the electrically conductive layer has a thickness of from 65 nm to 95 nm.
